(19) United States
(12) Patent Application Publication
(10) Pub. No.: US 2015/0362737 A1
(43) Pub. Date: Dec. 17, 2015

(54) WIDE FIELD IMAGING USING PHYSICALLY SMALL DETECTORS

(71) Applicant: YEDA RESEARCH AND DEVELOPMENT CO. LTD., Rehovot (IL)

(72) Inventors: Barak ZACKAY, Rehovot (IL); Avishay GAL-YAM, Rehovot (IL); Eran OFEK, Rehovot (IL); Sagi BEN AMI, Rehovot (IL)

(21) Appl. No.: 14/762,823

(22) PCT Filed: Jan. 28, 2014
(86) PCT No.: PCT/IL2014/050093

§ 371 Date: Jul. 23, 2015

Related U.S. Application Data
(60) Provisional application No. 61/889,195, filed on Oct. 10, 2013.
(60) Provisional application No. 61/757,246, filed on Jan. 28, 2013.

(51) Int. Cl. G02B 27/10; G06T 7/00; G02B 27/12; H04N 5/232

(52) U.S. Cl. CPC G02B 27/1066; H04N 5/23238; G06T 7/0081; H04N 5/23212; G02B 27/123

(57) ABSTRACT

An imaging method and system are provided, being particularly useful for imaging a relatively wide field of regard on a relatively small detection surface with high spatial resolution. The method comprises: creating a segmented image of a field of regard in an effective object plane, said image being formed by an array of N image parts of the field of regard; and projecting a selected number M≧1 of patterns of structured light onto a detection surface, which is located in a plane conjugate to the effective object plane and has geometry and size substantially of the image part, each of the M patterns being formed by selected K light components of said N image parts concurrently projected onto the entire detection surface forming a superposition of the K image parts, thereby enabling reconstruction of the image of the field of regard from detected number M of patterns of the structured light.

### TECHNOLOGICAL FIELD AND BACKGROUND

The present invention is generally in the field of imaging techniques, and relates to a system and method for imaging wide fields of regard using detectors with relatively small size of a light sensitive surface. The invention is particularly useful in astronomical applications, as well as biological application for sample inspection on a molecular level.

Surveying a large sky area is one of the most common and elementary types of observation. In principle, it is desired to image as wide an area of the sky as possible, at high spatial resolution and through a telescope with a large aperture, i.e. wide field of regard. Covering a wide field of regard at high spatial resolution requires a detector with a large physical area and many pixels, resulting in an expensive and complex system. The conventional imaging systems used in astronomy thus either utilize complex and expensive arrays of detectors, or detectors with relatively large pixels, at the expense of resolution.

### GENERAL DESCRIPTION

There is a need in the art for a novel technique enabling to use a detector of limited physical size for imaging (photographing) a large field of view (angular extent of target sky or remote background) with high spatial resolution (small pixel size) and minimal noise.

The present invention solves the above problem of imaging a relatively wide field of regard on a relatively small light sensitive surface with high spatial resolution by providing a novel optical system enabling “segmentation” of the wide field of regard into multiple narrower fields of view by means of arrangement of collimators. The segmenting optical system of the invention may be used in various applications including, but not limited to, a so-called “multiplexing imaging” method and system utilizing concurrent and/or sequential direction of light portions from numerous locations in the image plane of the optical system (which is the focal plane in a telescope) onto a single, e.g. small-size, detector, which records the so-obtained light, e.g. combined light being a superposition of image parts from many locations in the field of regard (sky locations), in a single digital image file. This technique may be followed by analysis using an appropriate image processing algorithm that recovers from the combined image the individual contribution of each location (sky location), enabling reconstruction of the sources within a wide field of regard (large sky area).

The multiplexing imaging system of the invention may be used in a charting mode for mapping the sources in a field of view which are unknown, as well as may be used in a reobserving mode for imaging known sources.

As will be described further below, in some embodiments, the technique of the invention is more effective for sparse fields of regard (images where many of the pixels do not contain information).

According to some embodiments of the invention, an imaging method comprises creating a segmented image of the field of regard in an effective object plane, the segmented image being formed by an array of N image parts of substantially identical geometry and size; and projecting structured light corresponding to the image parts onto a detection surface located in a plane conjugate to the effective object plane and having substantially said geometry and size of the image part.

It should be noted that the term “detection surface” used herein refers to a light sensitive surface of a detection unit or an intermediate projecting surface/window directing light indicative of an image of the field of regard towards a detection/measuring unit; such an intermediate projecting surface/optical window may be constituted a small entrance aperture of the detection/measurement unit.

In some embodiments, the projecting stage includes sequential projection of M different patterns of light components corresponding to different sets of the image parts, where each of the M patterns is formed by selected K parts of said N image parts (K<N) concurrently projected onto the entire detection surface forming a superposition of the K image parts. The M different patterns/sets of K image parts may be selected such that each of the N image parts is included in at least two of the M patterns, or some of the N image parts are included in only one of the M patterns. This enables reconstruction of the image of the field of regard from a sequence of M data pieces corresponding to the sequentially detected M different patterns of the structured light.

According to some other embodiments of the invention, the method comprises: dividing an effective object/image surface into an array of N parts of substantially identical geometry, and substantially identical to those of a detection surface located in a plane conjugate to a plane of the effective object surface, thereby enabling formation of an image of the field of regard in the form of an array of N image parts thereof. In case M=1 and K=N, some a-priori data about the field of regard is preferably utilized for analyzing such superposition image to learn about changes in the field of regard.

Thus, according to one aspect of the invention, it provides an imaging method comprising:

creating a segmented image of a field of regard in an effective object plane, said image being formed by an array of N image parts of the field of regard;

projecting a selected number M≧1 of patterns of structured light onto a detection surface, which is located in a plane conjugate to the effective object plane and has geometry and size substantially of the image part, each of the M patterns being formed by selected K light components of said N image parts concurrently projected onto the entire detection surface forming a superposition of the K image parts, thereby enabling reconstruction of the image of the field of regard from detected number M of patterns of the structured light.

The creation of the segmented image comprises dividing an effective image surface in said effective image plane into an array of N parts, thereby enabling formation of the segmented image of the field of regard in the form of the array of N image parts thereof.

In some embodiments, a-priori data about the field of regard is utilized for processing data indicative of the superposition image and performing measurements of sources within the image of the field of regard. In this case, the predetermined number of patterns may be M=1. In some other embodiments, e.g. when there is a priori data about the field of regard, the patterns include multiple M different patterns of K image parts selected such that each of the N image parts is included in at least one of the M patterns.

According to another aspect of the invention, it provides an imaging system comprising an optical assembly and a detection unit. The optical assembly comprises: an array of N substantially identical optical elements (optical windows) each comprising collimating optics, the optical elements being arranged in an effective object plane (i.e. located in a predetermined relation with respect to an image plane, i.e. substantially in the image plane or in a plane being one focal length far from the image plane) defined by the light collecting and focusing optics, e.g. a telescope, each of the optical elements being capable of receiving a light portion corresponding to a respective one of N image parts of the field of regard, thereby dividing an image of the field of regard into the N image parts and creating a segmented N-part image. The detection unit comprises a detection surface having geometry and size substantially of the image part, and located in a plane conjugate with said effective object plane.

According to yet another aspect of the invention, it provides an imaging system comprising an optical assembly and a detection unit. The optical assembly comprises: an array of N substantially identical optical elements (optical windows) arranged in an effective object plane (i.e. substantially in the image plane or in a plane being one focal length far from the image plane) defined by the light collecting and focusing optics, e.g. a telescope, each of the optical elements being capable of receiving a light portion corresponding to a respective one of N image parts of the field of regard, thereby dividing an image of the field of regard into the N image parts and creating a segmented N-part image; and an image controller configured and operable for sequentially activating M groups of the optical elements for projecting image parts onto a region in a plane conjugate to the image plane, where each of the M groups is selected to include K parts of the N image parts (K<N), such that each of the N image parts or some of the image parts is/are included in at least at least one of M groups thereby forming a sequence of M projections each being a superposition of the K image parts on the region in the plane conjugate to the image plane. The detection unit has a light sensitive surface located in said region and having geometry and size substantially equal to that of the optical element. The detection unit receives the sequence of the M projections, and generates a corresponding sequence of M data pieces, thereby enabling reconstruction of the image of the field of regard from this sequence of M data pieces.

The imaging system may be configured and operable for communicating the data indicative of the sequence of M data pieces to a processor utility (e.g. via a communication network) for reconstruction of the image of the field of regard. Alternatively, the imaging system may include such a processor utility as its constructional part being connected to output of the detection unit and to the image controller, and operable for receiving and processing the data indicative of the sequence of M data and reconstructing the image of the field of regard.

In some embodiments, the optical assembly comprises a spatial light modulator, where the optical elements are optical windows controllably switchable between their active and non-active states, for respectively including or not the respective light portion into the group of such portions to be concurrently projected onto the light sensitive surface.

The optical elements may be lenses or mirrors. For example, the image controller may comprise an array of shutters associated with the array of lenses/mirrors respectively, each of the shutters being controllably switchable between its operative and inoperative positions in which it is respectively in and out of optical path of light propagating towards the corresponding lens, thereby switching the lens between is inactive and active states, respectively. According to another example, the optical elements are mirrors, where each mirror is controllably movable between its operative and inoperative positions in which it is respectively in and out of optical path of light propagating towards the image plane, thereby selectively projecting the respective image part to the light sensitive surface (active state) or preventing it from reaching the light sensitive surface (non-active state). In yet further example, the optical elements are formed by polarizers controllably switchable between their active and non-active states, in which it allows light propagation to the detector or not.

This system can be used as a first stage, directing light from sources scattered in a wide field of view into a small entrance aperture of an additional measuring device (stage 2) such as a spectrograph (including integral-field or Fourier spectrographs), narrow-band imagers using filters or tunable filters, hyperspectral devices, photometers, polarimeters, fiber-fed devices or other instruments.

Considering astronomical applications, the technique of the present invention provides for increasing the sky coverage of all space telescopes operating in the IR, visible and UV frequencies by few orders of magnitude. The invention can significantly increase the volume of astronomical surveys, including search programs for exoplanets and transients using space and ground instruments. The system of the present invention may be combined with other techniques to help ground based telescopes get closer to their diffraction limit resolution by allowing a shorter exposure time.

The invention provides an imaging system that directs light from different locations on the image plane (focal plane in telescope-based systems) onto the same detector area enabling reconstruction of the original wide-field image. In this way, a physically small detector may be used to cover a wide field of view. The inventors conducted experiments using reconstruction algorithm for public space telescope data. The tests have demonstrated the reliability and power of the multiplexed imaging technique.

It should be understood that although the description below exemplifies the use of the present invention in astronomical application, the technique of the present invention is not limited to this specific example. The principles of the invention can generally be used with any optical system (collection and focusing optics) and can increase the effective field of view of such systems.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a block diagram of an example of the imaging system of the invention;

FIGS. 2A and 2B exemplify the operational principles of a segmenting arrangement of the system of the invention, where FIG. 2A shows the segmenting arrangement in which all the optical elements are in their active state, and FIG. 2B shows the segmenting arrangement in which a selected set of K optical elements is in the active state while the other optical elements are non active;

FIGS. 3A to 3E exemplify the operation of the segmenting arrangement together with focusing optics accommodated downstream of the segmenting arrangement, where FIGS. 3A and 3B illustrate schematically the configuration and a light propagation scheme in the segmenting arrangement, FIGS. 3C and 3D exemplify the focusing optics located downstream of the segmenting arrangement; and FIG. 3E shows the light propagation scheme in a combined optical system formed by the segmenting arrangement and focusing optics;

FIG. 3F shows schematically the experimental system utilizing the segmenting optics;

FIGS. 4A-4C show Digitized Sky Survey (DSS) images representing the sparsity variation of astronomical images across the sky, where FIG. 4A shows the galactic pole with Pd≈1/150, FIG. 4B shows a typical region at galactic latitude 19.1° with Pd≈1/34, and FIG. 4C shows the galactic center with Pd≈1/7;

FIG. 5 illustrates the principles of charting recovery algorithm where there is no prior knowledge of the position of every object in a field of regard and several sub-observations are to be obtained in order to recover the correct position of each object;

FIGS. 6A and 6B show two examples, respectively, for the flow charts of the main steps in a method according to the invention, where in the example of FIG. 6A the system operation utilizes the prior knowledge about the field of regard and reconstructs the image of the field of regard from a combined image formed by superposition of the N image parts, and in the example of FIG. 6B the system operates to reconstruct the image of the field of regard from a sequence of M images/sub-observations, each being a combined image formed by superposition of a different set of K image parts, where each image part is included in at least one observation;

FIGS. 7A and 7B exemplify sub-observations in a specific example of charting recovery algorithm of FIG. 5, using N=349, K≈175 and M=18; and

FIGS. 8A-8C show the results of the charting recovery algorithm, where FIG. 8A presents the original image with added background noise to match the theoretical SNR of the reconstructed image, FIG. 8B shows the reconstructed image with the same gray-scale as the original image, and FIG. 8C shows the difference between the images of FIGS. 7A and 7B.

### DETAILED DESCRIPTION OF EMBODIMENTS

The present invention provides a novel imaging technique suitable for imaging a wide field of regard on a relatively small size detector (i.e. its light sensitive surface). This significantly simplifies the configuration of an imaging system and reduces its costs.

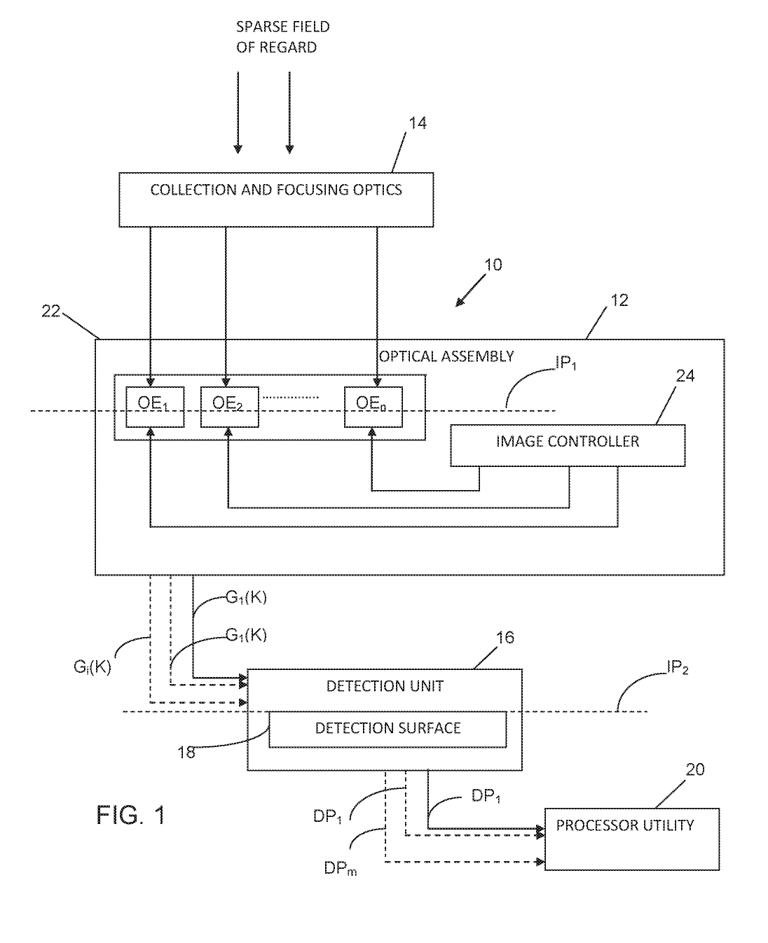

Reference is made to FIG. 1 showing, by way of a block diagram, an imaging system 10 of the present invention. The system 10 can generally be used with any imaging optics, namely collecting and focusing optics 14, as well as for imaging any object, real or imaginary, provided the F/# is known and stable. The light collecting and focusing optics 14 defines an image plane. The system 10 includes an optical assembly 12 which is to be accommodated such that its principle plane is located in an effective object plane IP₁ at a predetermined relation/distance with respect to the image plane defined by the light collecting and focusing optics 14, e.g. in the image plane itself (i.e. zero distance therefrom) or at a distance of one focal length from the image plane of the light collecting and focusing optics 14. Further provided in the system 10 is a detection unit 16 having a detection/receiving surface 18 accommodated in a plane IP₂ conjugate to the effective object plane IP₁.

It should be noted that in some applications, the detection/receiving surface 18 is constituted by a light sensitive surface of a photodetector. In some other applications, the detection/receiving surface is that in which a combined or multiplexed imaging occurs, and light indicative of a combined image is further projected onto a remote light sensitive surface, e.g. spectrometer. The detection unit may include additional elements, such as spectral splitter, etc. These additional elements are part of additional projection/processing optics and do not form part of the present invention, and therefore need not be specifically described. Output of the detection unit 16 is connectable (via wires or wireless signal transmission) to a processor utility 20 configured and operable to process image data, as will be described more specifically further below. Although in the description below the detection/receiving surface is referred to as “light sensitive surface”, it should be understood that the invention is not limited to this specific example.

The optical assembly 12 is configured for receiving light indicative of an image of a field of regard, formed by the collecting and focusing optics 14, and creating a segmented image divided into an array of N image parts of substantially identical geometry and size. To this end, the optical assembly 12 includes an image segmenting arrangement 22 formed by an array of N optical elements OE₁-OEₙ (which may or may not be similar/identical in geometry or shape), each for receiving a light portion corresponding to a respective one of N image parts of the field of regard. The principle plane of the segmenting optical elements is located at such distance from the image plane of the focusing optics 14 that light coming from the focusing optics 14 exits the optical system 12 in the form of an array of substantially parallel rays (collimated beams). This may be achieved by locating the principle plane of the image segmenting arrangement 22 at one focal distance from the image plane of the focusing optics 14.

As will be described more specifically further below, the segmenting assembly 22 is configured and operable for splitting light indicative of the image of the field of regard into N portions of collimated light components (corresponding to N image parts of the field of regard). These N collimated light portions can then be focused on the detection plane IP₂. To this end, an appropriate focusing optics is used, which may be part of the detection unit. In some applications, using a typical focusing optics of a conventional camera (pixel array detector) is sufficient. In some other applications, where improved focusing capabilities are required, a more complicated focusing optics may be used. This will be exemplified further below.

The image segmenting assembly 22 is controllably operable by an image controller 24 so as to provide a predetermined number M of combined images, each formed by a superposition of a set of K parts of the N image parts, by concurrently projecting the K parts onto a region in the plane IP₂ conjugate to the image plane IP₁. The light sensitive surface 18 of the detection unit is located in this region in plane IP₂ and has the geometry and size identical to those of the optical element.

As will be described more specifically further below, in some embodiments, where there is some prior knowledge about the field of regard being imaged (e.g. a previously acquired image of the same field of regard or at least a part thereof), there may be a single combined image (M=1) formed by superposition of all the image parts, i.e. K=N. In other embodiments, which are more suitable for the case where there is no prior knowledge about the field of regard, the image controller 24 operates the image segmenting assembly 22 so as to sequentially activate M different groups of the optical elements (M>1) for projecting image parts onto the light sensitive surface in the plane IP₂. Each of M groups includes a different set of K selected parts of the N image parts, such that each of N image parts is included in two or more of M groups. The light components (image parts) of the same group are concurrently projected onto the entire sensing surface 18, creating a combined image or a so-called “sub-observation”, being a superposition of the K image parts of the group.

Thus, the optical assembly 12 operates to create either one (M=1) or a sequence of M (M>1) combined images (sub-observations) on the light sensitive surface 18. The image segmenting arrangement 22 operates as a spatial light modulator, where the optical elements OE₁-OEₙ are optical windows, each being controllably switchable between its active and non-active states. Such optical elements/windows may be lenses or mirrors.

For example, the array of lenses or mirrors of the optical assembly 12 may be associated with a corresponding array of shutters of the image controller. Each shutter is controllably switchable between its operative (closed) and inoperative (open) positions. When the shutter is operative (closed) it is located in the optical path of light propagating towards the corresponding lens thus preventing the light to pass through the lens, and when the shutter is inoperative (open) it allows the light passage to the lens, thereby switching the lens between respectively inactive and active states thereof. In another variant, the optical elements may be mirrors (preferably with a lensing effect), and each mirror is mounted for movement between its operative and inoperative positions. When the mirror is in the operative position, it is in the optical path of light propagating towards the image plane thus projecting the respective light component onto the light sensitive surface of the detection unit, and when it is in the inoperative state it is out of the optical path thus preventing projection of the respective light component onto the detector. In yet further variant, the optical elements may be constituted by controllably operable polarizers.

Thus, the optical assembly 12 operates to project M different patterns, G₁(K)-Gₘ(K) of structured light onto the light sensitive surface 18. Each pattern presents a combined image/sub-observation formed by superposition of K light components of a different set of light components.

As shown schematically in FIG. 1, image data output from the detection unit is in the form of a sequence of M data pieces DP₁-DPₘ. The processor utility 20 receives this sequence (either directly from the detection unit or via a storage device (not shown) where the sequence may be previously stored), and processes this sequence to reconstruct the image of the wide field of regard. This will be exemplified further below.

The above-described system 10 of the invention can be used with any light collecting and focusing optics collecting light from a relatively wide field of regard, and in particular with light collecting and focusing optics applied to objects located at a focal distance from the imaging plane. This is the case for example for biological applications.

For effective image reconstruction using the technique of the invention the field of regard should preferably be sparse. A common feature of many astronomical images is that they are sparse, i.e. are almost empty. When picking a random patch of sky and observing it (not a specifically chosen close galaxy, nebula or dense star cluster), there are very few objects with non-zero flux. Most of them are either point source objects (the size of the seeing disk) or small patches (like distant galaxies) with sizes on the scale of a few arcseconds. The invention is applicable to such sparse images.

As described above, the optical assembly 12 of the present invention includes the segmenting arrangement 22 including an array of N optical elements which operate together to create from light indicative of the image of the field of regard a segmented image in the form of structured light of N spaced apart portions of collimated light components. The image controller operates to select a set of K optical elements for the formation a combined image therefrom.

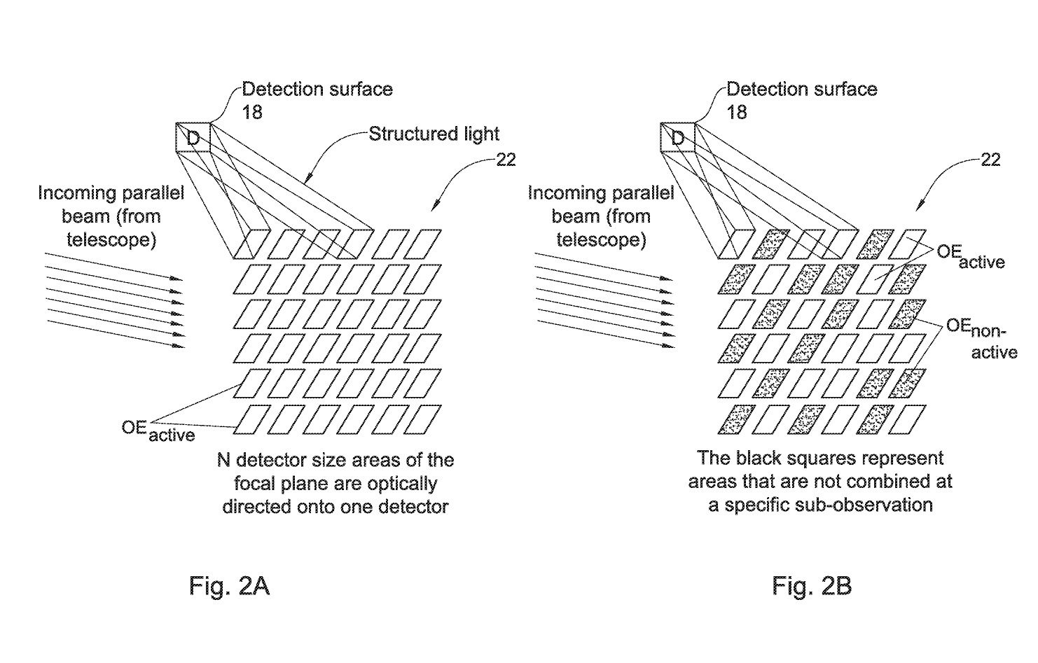

Reference is made to FIGS. 2A and 2B exemplifying the operational principles of the segmenting arrangement 22. As shown in the figure, the segmenting arrangement includes an array of N optical elements/optical windows, which in this specific not limiting example are arranged in a 2 dimensional array. In FIG. 2A, all the optical elements are in their active state denoted OE_{active}, all concurrently projecting the respective light components onto the same detection/receiving surface 18 forming a combined image on the detection surface. FIG. 2B exemplifies one sub-observation formed by a selected set of K optical elements which are in the active state, OE_{active}, projecting respective K light components onto the detection surface, while all other non-selected elements are in the non-active state, OE_{non-active}. Thus, in one sub-observation, only a subset of K focal plane areas is directed to the detection surface.

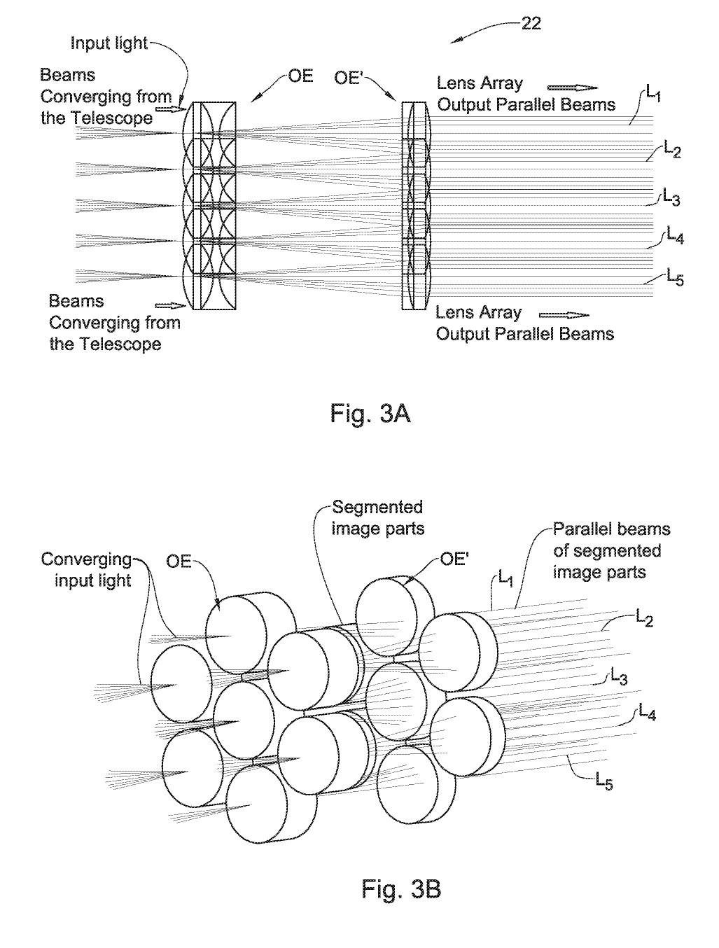

Reference is made to FIGS. 3A to 3E exemplifying the operation of the segmenting arrangement together with focusing optics accommodated downstream of the segmenting arrangement. This focusing optics may be part of the detection system, and may be of a conventional configuration.

FIGS. 3A and 3B illustrate schematically the configuration of and a light propagation scheme in the segmenting arrangement 22 for producing structured light formed by N spatially separated substantially parallel (collimated) light portions (five light portions L₁-L₅ in this not limiting example) corresponding to N image parts of the image of the field of regard. In this example, the segmenting arrangement includes array of optical elements OE-OE′ located so that the principal plane of the elements OE-OE′ is at one focal distance from the image plane of focusing optics 14.

Considering the example of a telescope configuration of the collecting and focusing optics (i.e. collection of light from infinity), the optical elements OE-OE′ are mounted on a telescope backplane. Also, in this example, the optical elements are lens assemblies. The accommodation of the co-aligned lens arrays OE and OE′ define a focal length f for each pair of matching lenses. The size of each lens in the array (i.e. the size of each optical window) is similar to the size of the detection surface. The array front principal plane is located at a distance f from the telescope image plane, so that beams from a single point in the telescope image plane come out substantially parallel with respect to each other, and with respect to beams from adjoint points in other lenses in the array. The optical elements OE-OE′ split the input light into spatially separated light components/portions corresponding to segmented image parts, resulting in the parallel light beams of the segmented image parts, which in turn propagate towards further focusing optics downstream of the segmented arrangement.

As indicated above, the focusing optics at the output of the segmented arrangement may be part of the detection unit. FIGS. 3C and 3D exemplify a focusing optics 30 located downstream of the segmenting arrangement, and having an entrance window of the size of the lens array exit window. This optics focuses each of the parallel beams L₁-L₅ onto a single point on the detection surface (e.g. camera focal plane).

In this example, the focusing optics 30 is configured as a composite system of 9 lenses in order to reduce chromatic aberrations and achieve a sub arcsecond image quality.

FIG. 3E shows the light propagation scheme in a combined optical system 40 formed by the segmenting arrangement 22 and focusing optics 30. As shown, when these two subsystems are combined, the end result is a multiplexed image where the multiplicity number is the number of segmenting optical assemblies in the array. Thus, the segmenting arrangement 22 performs segmentation of the image into an array of image parts and collimation of light portions corresponding to these image parts allowing their propagation to the detection surface. The focusing optics 30 focuses the collimated beams onto the detection surface.

FIG. 3F shows schematically the experimental system 50. The system includes a telescopic optics (collecting and focusing optics), and the combined optical system formed by the segmentation arrangement (associated with the image controller) and focusing optics associated with the detection unit. The system is mounted to the telescope back plane TBP. The segmenting optics is mounted into a hive-like cylinder C₁. The focusing optics is mounted further downstream to another cylinder C₂. Finally, a detector is located at the focusing optics image plane.

This combined optical system has two focal planes. The first focal plane is the telescope focal plane (defining the effective object plane for accommodation of the segmentation arrangement) that can be controlled by adjusting a distance between the telescope primary and secondary mirrors. The second focal plane is the detector focal plane (detection/receiving surface), the correct position of which can be controlled using a mechanical mechanism.

As indicated above, the invention uses the sparse nature of images (e.g. astronomical images) to effectively measure all objects contained in the corrected field of view of an optical system (telescope) using a physically small detector, without reducing the spatial resolution. This is done by simultaneously projecting different regions of the image plane (which coincides with the focal plane in case of telescope) onto the same detector.

Because of the sparsity of objects, scientific measurements can be performed using the combined images with the same quality and greater efficiency compared to mosaicking. Flux measurements of known sources in combined images can be done directly (e.g., to search for transients and planets). Using the sequence of so-called “sub-observations”, i.e. M sub-observations (M>1) of K image parts (K<N), it is possible to chart an unknown part of the field of regard (sky).

Each sub-observation is a measurement of the sum of the flux from K areas on the image/focal plane. The time each observation takes depends on the exposure time Tₑ, readout time Tᵣ and slew time Tₛ. When referring to two different exposure times, the duration of multiplexed imaging will be denoted by T*_{θ}. The total time required for one observation using multiplexed imaging is given by:

T*ₜₒₜₐₗ=M(T*_{θ}+Tᵣ)+Tₛ

Regular imaging can be considered as multiplexed imaging with K=1 and M=N (it will take N observations to cover the whole area). In that case:

Tₜₒₜₐₗ=N(T_{θ}+Tᵣ+Tₛ)

The efficiency E of the system is given by the time required to cover the described area with the regular mode divided by the time required to do so with the multiplexed method, when both observations have the same signal to noise (SNR), meaning that:

$$E = \frac{N ( {T}_{e} + {T}_{r} + {T}_{s} )}{M ( {T}_{e}^{*} \vert {T}_{r} ) \vert {T}_{s}}$$

(and T*_{θ} is adjusted to match the SNR).

For example, under the assumptions that

T_{θ}>>Tₛ+Tᵣ (1)

(which is not always the case, as will be described further below) and

MT*_{θ}=T_{θ}

(which will make the SNR equal when the dominant source of noise is Poisson noise), this yields:

$$E = \frac{N ( {T}_{e} + {T}_{r} + {T}_{s} )}{M ( {T}_{e}^{*} + {T}_{r} ) + {T}_{s}} \approx \frac{{NT}_{e}}{{T}_{e}} \approx N .$$

Let us define the object surface density d to be the number of sources in one part of the field of regard (sky) divided by the area of sky observed; denote by P the average (over sources with different intensities and sizes) number of pixels that have a statistically significant contribution per object. Further, let us assume that a sky area is sparse, namely that Pd<<1.

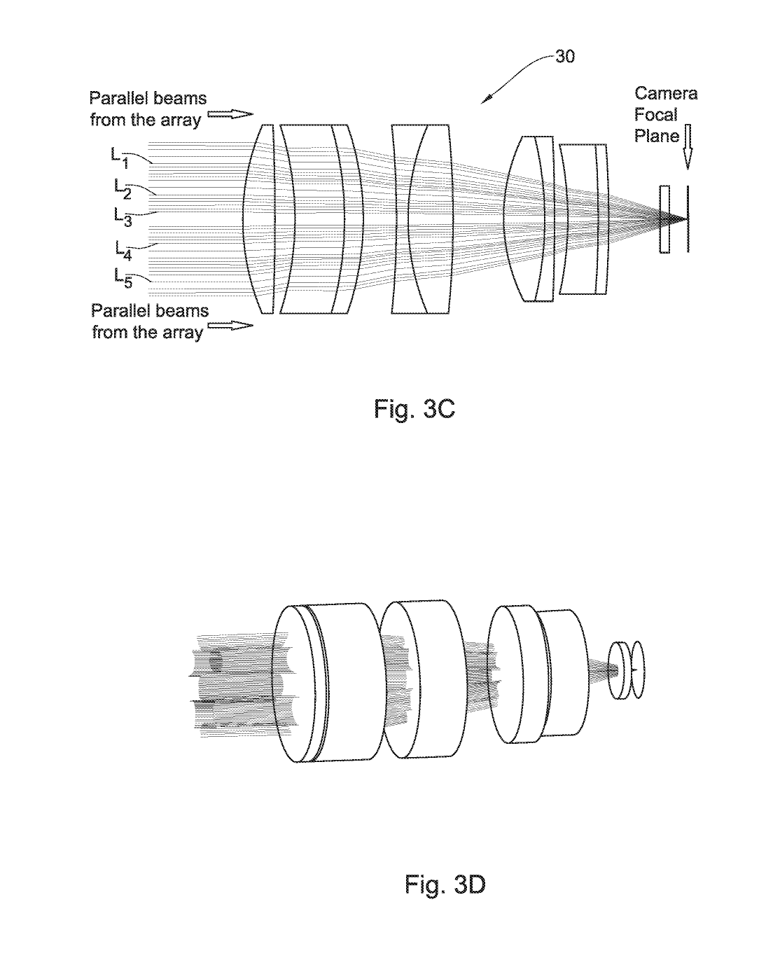

In this connection, reference is made to FIGS. 4A-4C, showing Digitized Sky Survey (DSS) images representing the sparsity variation of astronomical images across the sky. FIG. 4A shows the galactic pole with Pd≈1/150, FIG. 4B shows a typical region at galactic latitude 19.1° with

$$Pd \approx \frac{1}{34} ,$$

and FIG. 4C shows the galactic center with

$$Pd \approx \frac{1}{T} .$$

It should be noted that the density estimate Pd depends on the depth of the image, the resolution and the seeing, and therefore imaging the same area with different instruments might yield different densities.

The best possible multiplexing and the absolute upper limit on K satisfies KPχ≈1, which means that a non-trivial flux is measured with every pixel of the detector. Generally, density estimate Pd depends on many parameters such as the depth of the observation (image), the spectral band, the field observed, the plate scale and the seeing, and therefore imaging the same area with different instruments might yield different densities.

The following are Pd values for a few common surveys:
80s near-UV exposures with GALEX toward high galactic latitudes (as will be described below) have

$$Pd ∼ \frac{1}{1000} ;$$

For Sloan Digital Sky Survey (SDSS) g-band (550-685 nm) imaging toward the north galactic pole,

$$Pd ∼ \frac{1}{500}$$

is measured
For Palomar Transient Factory (PTF) single 60s r-band (570-730 nm) exposures toward the galactic pole,

$$Pd ∼ \frac{1}{100} .$$

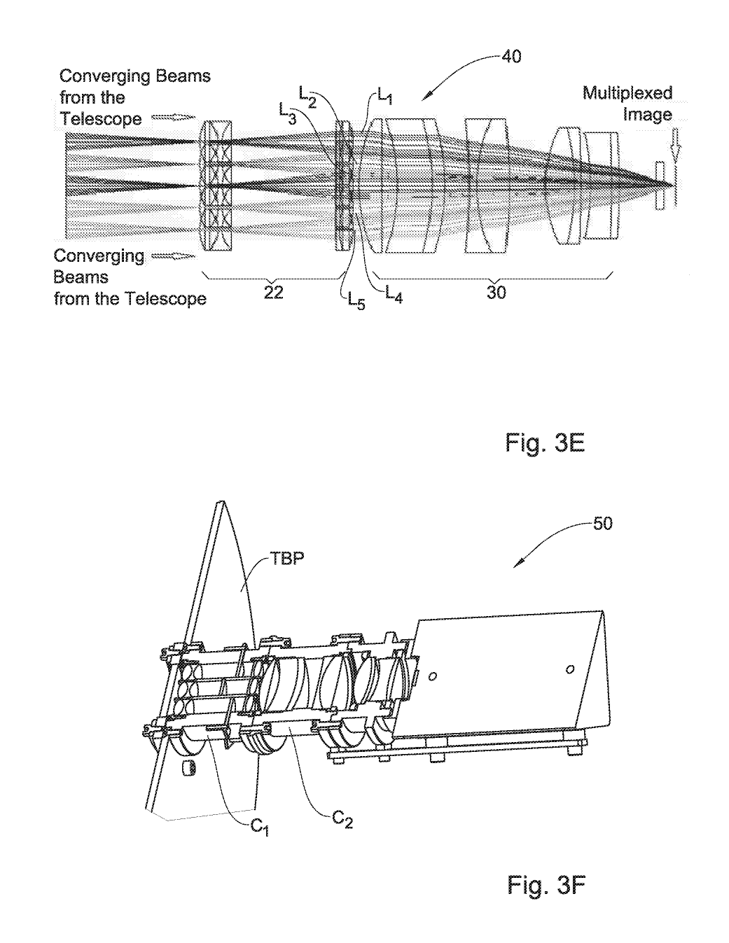

When recovering the original observation, two scientific cases are considered: charting and re-observing. Charting is defined as an observation of a part of the sky that is unknown to the resolution and depth in question. In this mode, since there is no prior knowledge of the position of every object, then in order to recover the correct position of each source, several sub-observations are to be obtained, allowing for each part of the sky to have a specific pattern of appearance, as illustrated in FIG. 5.

For re-observing mode, a prior knowledge (e.g. image) of the relevant region of the sky is used. The observational goal in re-observing mode is to measure the flux from previously known objects, measuring variability or searching for new transients. In the re-observing mode, for each pixel on the image a-priory (using the known mapping of the sky) it can be calculated which areas on the focal plane contribute to the measured flux, allowing for a simple recovery algorithm. The number of sub-observations required and therefore also the efficiency depends on whether it is required to measure all the objects in the field, or just as many of them as possible.

The case where it suffices to measure only most of the objects, as well as that of sparse field of regard, the use of a single observation (M=1, K=N) may be sufficient, provided some a-priori data about the field of regard exists, e.g. a prior image of the relevant region of the sky (re-observing mode). With recent developments in the recording of a multi-wavelength static image of much of the sky, the re-observing mode is likely to be the common mode. The present invention, however provides also an effective solution for the charting mode (there is no prior knowledge about the field of regard being imaged) for imaging sparse fields of regard, by using a few sub-observations and an appropriate image processing algorithm.

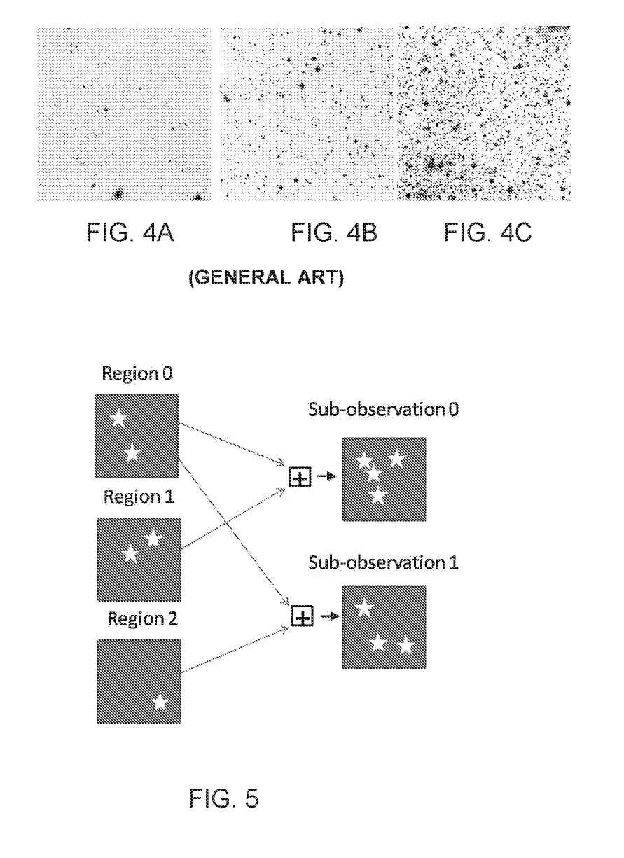

Reference is made to FIGS. 6A and 6B showing, in self-explanatory manner, two examples, respectively, for the flow charts of the main steps in a method according to the invention. In the example of FIG. 6A, the system operates to utilize the prior knowledge about the field of regard and reconstruct the image of the field of regard from a combined image formed by superposition of the N image parts. In the example of FIG. 6B, the system operates to reconstruct the image of the field of regard from a sequence of M images/sub-observations, each being a combined image formed by superposition of a different set of K image parts, where each image part is included in at least one observation.

The following is the description of the technique of constructions of the sets of image parts. To this end, the following definitions are made: The set of sky regions combined during sub-observation 0≦i<M is denoted by cₜ; the flux recorded in sub-observation i at pixel location x is denoted by fᵢ(x); and the flux arriving to pixel x from region j on the focal plane is denoted by gⱼ(x). The expected flux (without noise) at each pixel is therefore

$${f}_{i} ( x ) - {\sum }_{j ∈ {C}_{i}} {g}_{j} ( x )$$

Further, for each region j on the focal plane, the representing vector (a binary vector of length M) vⱼε(0,1)^{M} indicating if the flux from region j is combined during sub-observation t.

$${v}_{j} [ i ] = \{ \begin{matrix}0 & j ∉ {C}_{i} \\ 1 & j ∈ {C}_{i}\end{matrix}$$

and the set of representing vectors is denoted V=( [symbol] )ᵢ₌₀^{N-1}. The representing vectors determine uniquely the set of regions that are included in each sub-observation and they can be chosen by the algorithm designer ahead of making the observation. This allows to choose in a special way the set of vectors such that there will be no ambiguity in the reconstruction algorithm.

The vector of measured fluxes [symbol] from all sub-observations at a pixel x on the detector is denoted by

[symbol]

=(f₀[x],f₁[x], . . . ,f_{M-1}[x])

If a specific pixel x has exactly one non-zero flux contribution coming from a specific sky region j then there exists a real number a such that

[symbol]

=a

[symbol]

When constructing the sets, the recovery ambiguity problem has to be dealt with. To demonstrate it, a simple example of a multiplexing scheme is used with the set of parameters: N=3, K=2 and M=2. This is shown in FIG. 5. The the focal plane sub-areas are denoted by (0,1,2). The sets used are c₀=(0,1) and C₁=(0,2). The sub-observations used are therefore f₀(x)=g₀(x)+g₁(x) and f₁(x)=g₀(x)+g₂(x). The representing vectors will be [symbol] =(1,1), [symbol] =(1,0), [symbol] =(0,1). For every pixel location x, vector [symbol] =(f₀(x),f₁(x)) can be constructed.

If for a pixel location the following is observed:

[symbol]

=(a,0)=a(1,0)=a

[symbol]

then it can be deduced that g₁(x)=a and g₀(x)=g₂(x)=0.

If for a pixel location, the following is observed:

[symbol]

=(0,a)=a(0,1)=a

[symbol]

then it can be deduced that g₂(x)=a and g₀(x)=g₁(x)=0.

If for a pixel location, the following is observed:

[symbol]

−(a₁,a₁)−a₂(1,0)+a₂(0,1)+(a₁−a₂)(1,1)−a₂ [symbol] +a₂ [symbol] +(a₁−a₂)

[symbol]

Then it can be deduced that g₀(x)=a₁−a₂ and g₁(x)=g₂(x)=a₂.

This demonstrates a possible ambiguity, even without considering observational errors. There could be more than one combination of fluxes that will generate the same observed vector. In this example, 3 free parameters are to be measured but there are only 2 measurements. This is where the sparsity assumption is necessary. The original image is assumed to be sparse, meaning that most of the measured parameters are 0, and therefore the correct recovery in this case is assumed as g₀(x)=a₁ and g₁(x)=g₂(x)=0.

If for a pixel location, it is observed that [symbol] =(a₁,a₂), then the original fluxes cannot be recovered because the following cases are equally likely:

g₀(x)=0,g₁(x)=a₁ and g₂(x)=a₂

g₀(x)=a₁,g₁(x)=0 and g₂(x)=a₂−a₁.

In this case, the ambiguity cannot be solved, and one can determine neither the locations nor the fluxes of the non-zero sources. Therefore, the sets Cᵢ should be constructed carefully, preventing ambiguities when few sources are contributing non-zero flux to a pixel location.

To prevent ambiguities, the following may be considered. The most basic requirement on the selected sets is that if there is only one non-zero flux contributing to a location x then the recovery is unique. From here, a condition for the construction of the set V can be deduced: For every pair of different vectors, [symbol] , [symbol] εV and for all pairs of real numbers a,b≠0 the following condition is to be satisfied:

a [symbol] ≠b

[symbol]

This condition, implying [symbol] ≠ [symbol] and [symbol] ≠ [symbol] , ∀vεV, defines the absolute lower bound for the number of sub-observations to chart N regions of the focal-plane, which is log₂(N+1).

It is sub-optimal to recover only objects that do not overlap with other objects (this limits the multiplexing number N (and therefore K) to be smaller than desired, leading to smaller region of the sky being observed). Therefore, it is desired to construct the sets such that unique recovery is guaranteed also when two objects fall on the same detector area (and with high probability will be unique even when there are 3 or more objects falling on the same detector area). In the case of two objects, in a similar fashion, we have

[symbol]

=x₁ [symbol] +a₂

[symbol]

Again, the set V is chosen to hold an analogue condition: For every quadruplet of different vectors, [symbol] , [symbol] , [symbol] , [symbol] εV and for all quadruplets of real numbers a₁, a₂,b₁ b₂ the following condition is to be satisfied:

a₁ [symbol] +a₂ [symbol] ≠b₁ [symbol] +b₂ [symbol] (2)

In the simple example above, this condition is not satisfied, as

[symbol]

+ [symbol] =

[symbol]

This fact is the cause of the ambiguity in the recovery.

When considering the charting of weak sources, another source of confusion can be the noise (of all kinds). If two regions of sky have close representing vectors, i.e ∥ [symbol] − [symbol] ∥² is small, then flux coming from region i might be confused with flux coming from region j. This is because the recovery algorithm can use only sub-observations that contain only one of the regions i, j to distinguish between sources coming from region i and sources coming from region j. The SNR of one sub-observation is lower than the SNR of the reconstructed observation, meaning that statistically significant sources on the reconstructed image might not be significant in one sub-observation. This means that weak (yet statistically significant sources) which are non-significant in a single sub-observation can be mistakenly misplaced to positions with a representing vector which is close to the representing vector of the correct position. Therefore, the representing vectors should preferably be chosen such that the difference between every pair of vectors is non-zero in at least r coordinates.

∥ [symbol] − [symbol] ∥²≧r (3)

The proper construction of a set maintains the conditions (2) and (3) above. Generally, it should be understood that this can be done for a multiplexing of N with M≈2 log₂(N) if a robust recovery is desired. In a slightly less robust case, when in the above notation

$$\frac{\vert {a}_{1} - {a}_{2} \vert}{\sqrt{{σ}_{noise}^{2} + {a}_{1}}} > γ \approx 5$$

(γ is a confidence parameter of the algorithm (as will be described below), this condition means that with high probability there is no confusion between a₁ and a₂ due to noise), then as little as M≈log₂(N)+log₂(log₂(N)) sub-observations can be used for full recovery. On the simple example presented above, the minimal set that satisfies condition (2) and condition (3) with r=2 is:

V=((0,1,1),(1,0,1),(1,1,0))

The following is a more detailed example of construction of such set V maintaining conditions (2) and (3) to avoid ambiguity in the recovery of two interfering sources. First, let us consider vector [symbol] to be a linear combination of two binary vectors, [symbol] =+c [symbol] +d [symbol] , such that all the numbers in the set (a, b, a+b) appear in \dot{μ}. Then, the only set of numbers (c, d) such that ∃\dot{v},\dot{w} binary vectors and [symbol] =c [symbol] +d [symbol] , is (a, b). Assuming that there exists c, d, [symbol] , [symbol] such that [symbol] =c [symbol] +d [symbol] , we obtain W.l.o.g, a<b and c<d. Since [symbol] , [symbol] are binary vectors, the only numbers that can appear in [symbol] are 0,c,d,c+d. So, the sets (0, a, b, a+b), (0,c,d, c+d) are to be equal, but since both sets are sorted, this means that a=b=d.

Assuming that

$$\frac{\vert a - b \vert}{\sqrt{a + {σ}_{noise}^{2}}} > γ ,$$

the numbers (0, a, b, a+b) are statistically distinguishable in the measurement, meaning that for each index i in the vector μ one can decide which of the values (0, a, b, a+b) μ┌i┐ gets. This means that μ can be constructed as μ=avⱼ bvₗ with no confusion, leading to a correct recovery of the indices j,l.

In order to construct the set V, it should be understood that for every pair of binary vectors v≠w with equal sum K where K>M/2, all the numbers a, b, a+b appear in the sum a [symbol] +b [symbol] . The sum of v+w is 2K which is distributed over M coordinates, and 2K>M meaning v+w contains a coordinate with weight larger than 1, so a [symbol] +b [symbol] contains the number a+b. Since v≠w there is at least one coordinate where they are different and they both have the same number of 1's, so they must be different on an even number of places. Therefore a and b also appear in a [symbol] +b [symbol] .

To assure that all the numbers (a, b, a+b) appear in every combination of avⱼ+bvₗ for every vⱼ≠vₗΣV, the set v can be chosen to be a set of binary vectors with equal sum, and chosen to be

$$\frac{MK}{N} .$$

Having |V|=N, M can be determined by the relation:

$$N < ( \begin{matrix}M \\ \frac{MK}{N}\end{matrix} )$$

deriving that

M−a log(N)+β log(log(N))

Using an example ratio of

$$\frac{K}{N} = \frac{1}{2} ,$$

we obtain α=1, β=0.5.

If one needs to recover the position in the situation where a=b (or a and b are indistinguishable due to noise), then only one way is needed to recover v, wεV from v+w. It might be also desired to enforce that every pair of vectors are sufficiently distant to help reduce the confusion in the positions of weak sources. Both conditions can be satisfied by constructing the set V from the empty set by inserting vectors with exactly

$$\frac{MK}{N}$$

ones in a random order, verifying the condition v₁+v₂≠w₁+w₂ for every quadruplet of V and the condition ∥vₗ−vⱼ∥≧r at every time. Experiments have shown that the achieved M with this process is roughly M≈2 log(N) with r=4, which is about twice the value of M needed without the above limiting conditions.

For the charting recovery algorithm, a detailed description of which will be presented below, the input data includes vector [symbol] for every pixel position x. The output of the algorithm includes the fluxes, a₀, a₁, . . . and the locations they are coming from, i₀, i₁, . . . , contributing to pixel x. The main steps in this algorithm may be exemplified as follows:

(a) All vectors [symbol] εv are reviewed to find the optimal value for a>0 and i such that ∥ [symbol] −a [symbol] ∥² is minimal. The best position and flux α are considered. If α<γσₙₒᵢₛₑ, algorithm is stooped and all pairs of i, α that were found before are output.

(b) Then, vector [symbol] is updated [symbol] =z,73 −a [symbol] ;
(c) Step (a) is repeated.

The above is the simplest example of a generally more complex recovery algorithm presented below. This simple algorithm does not treat the case a₁=a₂. The inventors have noted that using the information from neighboring pixels provides for easily solving ambiguities rising from the case a₁=a₂.

The following are simulation results of employing this simple algorithm (without using data from neighboring pixels) to real data from GALEX. To simulate the operation of the charting algorithm, several simulations were performed using data observed with the GALEX satellite (scanning mode with 80 seconds exposure time). These observations were targeted at high galactic latitude, and therefore were sparse, with a measured sparsity

$$Pd ∼ \frac{1}{1000}$$

allowing for high multiplexing. The simulation used 349 regions, 1000×1000 pixels each, with K=175 and M=18. To study the performance of the recovery, the reconstructed image was compared with the original image with added background noise. Each reconstructed sky region is the average of 9 sub-observations in which it is contained. Therefore the theoretical standard deviation of the reconstructed image is

$${σ}_{rec} = \frac{{σ}_{sub}}{\sqrt{9}} .$$

A set v was generated satisfying i conditions (2) and (3) with r=4 (the closest pair of vectors is different in 4 coordinates).

The experiments showed a high fidelity (>95%) for recovering the correct positions of all the 7σ_{rec} (and >99% at 8σ_{rec} and above) pixels which have flux contribution from 1 source, and a high fidelity of recovering the correct combination of pixels with flux contribution of 2 or more sources.

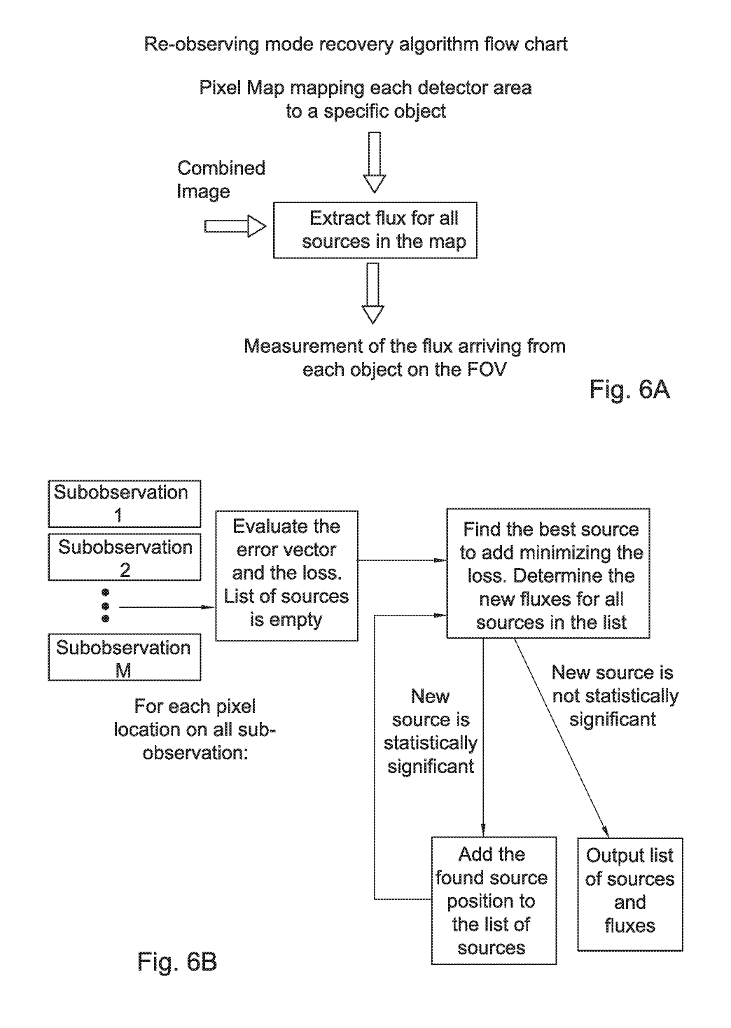

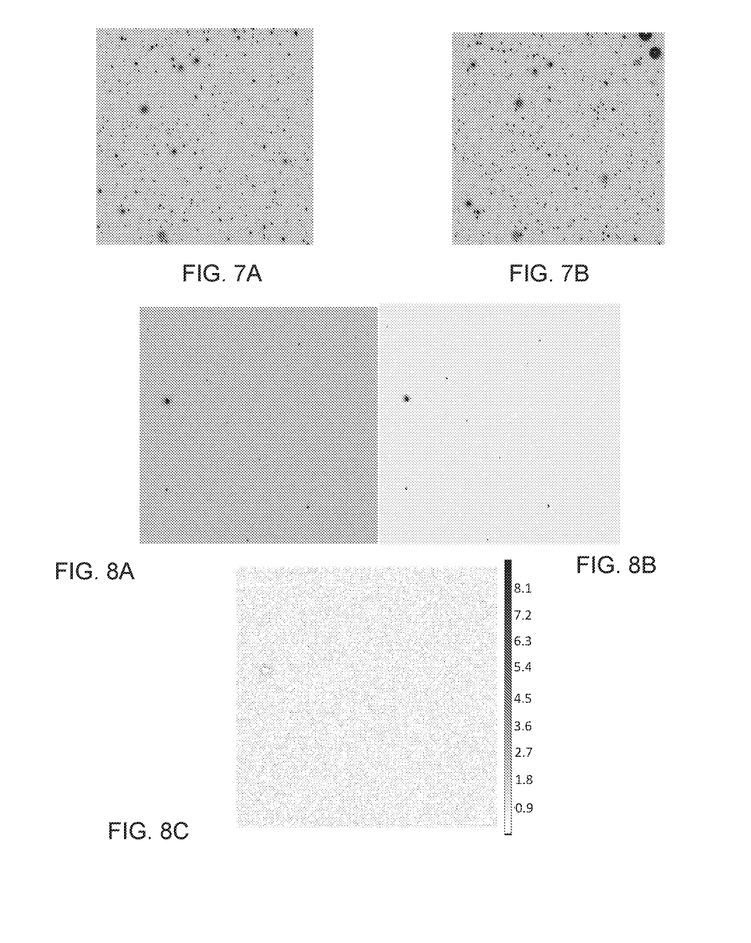

In this connection, reference is made to FIGS. 7A-7B and 8A-8C. FIGS. 7A and 7B show examples of simulated sub-observations using N=349, K≈175 and M=18, used as input to the charting recovery algorithm. It should be noted that some objects appear in both images and some appear in only one of them. FIGS. 8A-8C show the results of the charting recovery algorithm. FIG. 8A presents the original image with added background noise to match the theoretical SNR of the reconstructed image. FIG. 8B shows the reconstructed image with the same gray-scale as the original image. It should be noted that only significant pixels have non-zero value. FIG. 8C shows the difference between the images of FIGS. 7A and 7B. The gray-scale bar relates to FIG. 8C only and is in units of standard deviations of the background in the original image of FIG. 8A.

The following is a more detailed example of the charting recovery algorithm. Defining the confidence parameter as γ≈5, the following steps are performed for every pixel x on the detector:

(1) Vector [symbol] is considered as the vector of all its sub-observations, and the set w=Ø is initializes.

(2) The error vector is constructed as [symbol] =\sqrt{ [symbol][i]+Kσ_{background}²+σ_{read}²}, and the loss is set as

$$S = {‖ \frac{μ}{{σ}_{x}} ‖}^{2} .$$

(3) For every vεV, weighted least squares are used to find the parameters αᵢ,β such that the loss

$$\vert \frac{\overleftarrow{μ} - {\sum }_{{w}_{i} ∈ W} {α}_{i} {w}_{i} - β \overleftarrow{υ}}{\overleftarrow{{σ}_{x}}} \vert$$

is minimal, and the pair v,β is chosen that minimizes the loss

(4) Then, if

$$S - {\vert \frac{\overleftarrow{μ} - {\sum }_{{w}_{1} ∈ W} {α}_{i} {w}_{i} - β \overleftarrow{υ}}{\overleftarrow{{σ}_{x}}} \vert}^{2} > {γ}^{2} ,$$

the following is performed:
(i) adding v to the chosen vectors set W;
(ii) setting the loss

$$S = {\vert \frac{\overleftarrow{μ} - {\sum }_{{w}_{1} ∈ W} {α}_{i} {w}_{i} - β \overleftarrow{υ}}{\overleftarrow{{σ}_{x}}} \vert}^{2}$$

(iii) repeating stage 3.

(5) The weighted least squares algorithm is used to find αᵢ, which minimizes

$${\vert \overleftarrow{μ} - {\sum }_{{{w}_{1} ∈ W}_{\overleftarrow{{σ}_{x}}}} {x}_{i} {w}_{i} \vert}^{2} ,$$

and all the couples ωᵢ,αᵢ are output.

The following is the description of the efficiency analysis conducted by the inventors for the above-described technique.

As indicated above, the efficiency E of the system is given by the time required to cover the described area with the regular mode divided by the time required to do so with the multiplexed method, when both observations have the same signal to noise (SNR), meaning that:

$$E = \frac{N ( {T}_{e} + {T}_{r} + {T}_{s} )}{M ( {T}_{e}^{*} + {T}_{r} ) + {T}_{s}}$$

To understand the behavior of the efficiency

$$E - \frac{N ( {T}_{e} + {T}_{r} + {T}_{s} )}{M ( {T}_{e}^{*} + {T}_{r} ) + {T}_{s}} ,$$

one needs to know the exposure time factor

$$\frac{{T}_{e}^{*}}{{T}_{e}} .$$

This factor is determined by the constraint on E comparing the time needed for observations with equal SNR. The exposure time factor changes when different noise sources are dominant and for various observing modes (re-observing vs charting), and therefore each case is to be handled separately. The efficiency for all cases (assuming condition (1)) is summarized in the following table.

| Observing mode\ | | Background | |
|---|---|---|---|
| Dominant noise | Poisson | noise | Read-noise |
| Re-observing | K | 1 | K |
| Charting | K | 1 | $\frac{K}{\sqrt{{log}_{2} ( N )}} < E = \sqrt{\frac{NK}{M}} < K$ |

As will be described below, the efficiency of background dominated observations can be improved if condition (1) is invalid and Tᵣ+Tₛ are not negligible compared to T_{θ}.

Let us denote the background noise in observation i coming from region at pixel x as b_{i,j}(x), and denote the read noise in observation i at pixel x by rᵢ(x). The notation P(λ) is used to denote a Poisson random variable with expectancy λ (where λ is in units of photons). Let us assume that all are independent random variables and that the background and read noise have mean 0 and standard deviations σ_{b}, σᵣ respectively (and otherwise subtract the mean). To calculate the SNR of an observation, assuming that only one region c̅ contributes non-zero flux g, to pixel x, lets first look at a specific sub-observation:

$$\begin{matrix}{f}_{i} ( x ) = P ( {\sum }_{j ∈ {C}_{i}} {g}_{j} ( x ) {T}_{e}^{*} ) + {\sum }_{j ∈ {C}_{i}} \sqrt{{T}_{e}^{*}} {b}_{i , j} ( x ) + {γ}_{i} ( x ) \\ = P ( {g}_{\overline{c}} {T}_{e}^{*} ) + {\sum }_{j ∈ {C}_{i}} \sqrt{{T}_{e}^{*}} {b}_{i , j} ( x ) + {r}_{i} ( x )\end{matrix}$$

For each region c̅ we have

$$\vert \{ i s . t . c ∈ {C}_{i} \} \vert \approx \frac{MK}{N}$$

(the number of sets Cᵢ that contain c̅) sub-observations containing it (in each sub-observation we observe K parts, there are M such sub-observations and the total number of parts is N). Assuming the common case that only the region c̅ contributes non-zero flux to pixel x, the best SNR of region c̅ is achieved when taking the average of all sub-observations i for which c̅εCᵢ, meaning that the best flux estimation of region c̅ is

$${F}_{\overline{c}} = \frac{{\sum }_{\{ i s . t . \overline{c} ∈ {C}_{i} \}} P ( {T}_{e}^{*} {g}_{\overline{c}} ) - {\sum }_{\{ i s . t . \overline{c} ∈ {C}_{i} \}} {\sum }_{j ∈ {C}_{i}} \sqrt{{T}_{e}^{*}} {b}_{i , j} ( x ) + {\sum }_{\{ i s . t . \overline{c} ∈ {C}_{i} \}} {r}_{i} ( x )}{\vert \{ i s . t . \overline{c} ∈ {C}_{i} \} \vert}$$

Multiplying the signal by a factor does not change the SNR so

$$\begin{matrix}\frac{MK}{N} {F}_{\overline{c}} \approx \vert \{ i s . t . \overline{c} ∈ {C}_{i} \} \vert {F}_{\overline{c}} \\ = {\sum }_{\{ i s . t . \overline{c} ∈ {C}_{i} \}} P ( {T}_{e}^{*} {g}_{\overline{c}} ) + {\sum }_{\{ i s . t . \overline{c} ∈ {C}_{i} \}} {\sum }_{j ∈ {C}_{i}} \sqrt{{T}_{e}^{*}} {b}_{i , j} ( x ) + \\ {\sum }_{\{ i s . t . \overline{c} ∈ {C}_{i} \}} {r}_{i} ( x )\end{matrix} \qquad ( 4 )$$

Now, the efficiency of the method is analyzed assuming that different parts of the noise are dominant.

Assuming Poisson noise is the dominant noise source, equation 4 can be rewritten as

$$\frac{MK}{N} {F}_{\overline{c}} \approx {\sum }_{\{ i s . t . \overline{c} ∈ {C}_{i} \}} P ( {T}_{e}^{*} {g}_{\overline{c}} ) = P ( \frac{MK}{N} {T}_{e}^{*} {g}_{\overline{c}} )$$

One can choose

$${T}_{e}^{*} = \frac{{NT}_{e}}{MK} ,$$

so the equation becomes

$$\frac{MK}{N} {F}_{\overline{c}} \approx P ( \frac{MK}{N} {T}_{e}^{*} {g}_{\overline{c}} ) = P ( {T}_{e} {g}_{\overline{c}} )$$

and the same SNR is obtained as in the original observation. This means that the efficiency is

$$E = \frac{N ( {T}_{e} - {T}_{r} + {T}_{s} )}{M ( {T}_{e}^{*} + {T}_{r} ) + {T}_{s}} \approx \frac{{NT}_{e}}{{MT}_{e}^{*}} = \frac{{NT}_{e}}{M \frac{{NT}_{e}}{MK}} = K$$

This means that in both observing modes the multiplexed imaging gains maximal efficiency when the dominant noise is Poisson noise, and since there is no dependence on M one can use large numbers of sub-observations guaranteeing high stability for the recovery algorithm.

Assuming background noise is the dominant noise source and the fact that b_{i,j} are all independent, equation 4 above can be rewritten as

$$\begin{matrix}\frac{MK}{N} {F}_{\overline{c}} \approx \frac{MK}{N} {T}_{e}^{*} {g}_{\overline{c}} + {\sum }_{\{ i s . t . \overline{c} ∈ {C}_{i} \}} {\sum }_{j ∈ {C}_{i}} \sqrt{{T}_{e}^{*}} {b}_{i , j} ( x ) \\ = \frac{MK}{N} {T}_{e}^{*} {g}_{\overline{c}} + \sqrt{\frac{MK}{N} {KT}_{e}^{*}} b ( x )\end{matrix}$$

Now, the SNR can be calculated when using multiplexed imaging:

$${SNR}^{≯} = \frac{\frac{MK}{N} {T}_{e}^{≯} {g}_{\overline{c}}}{\sqrt{\frac{MK}{N} {KT}_{e}^{≯}} {σ}_{b}} = \sqrt{\frac{M}{N} {T}_{e}^{≯}} \frac{{g}_{\overline{c}}}{{σ}_{b}}$$

Keeping in mind that that the original SNR was

$$S N R = \frac{{T}_{e} {g}_{\overline{c}}}{√ {T}_{e} {σ}_{b}} = \sqrt{{T}_{e}} \frac{{g}_{\overline{c}}}{{σ}_{b}}$$

then for equal SNRs,

$${T}_{e}^{≯} = \frac{{NT}_{e}}{M} .$$

This means that the efficiency is

$$E = \frac{N ( {T}_{e} + {T}_{r} + {T}_{s} )}{M ( {{T}_{e}}^{≯} + {T}_{r} ) + {T}_{s}} \approx \frac{{NT}_{e}}{{MT}_{e}^{≯}} = \frac{{NT}_{e}}{M \frac{{NT}_{e}}{M}} = 1$$

Although in some cases the technique is less efficient when the dominant noise is the background because the efficiency ratio is 1, there are applications (for example when performing shallow surveys) for which the assumption that T_{θ}>>Tᵣ+Tₛ cannot be satisfied because the required exposure time for the observation is small compared to slew time or readout time. In these cases, the multiplexed imaging technique allows using M exposures with a factor of

$$\frac{N}{M}$$

larger exposure time instead of iv different exposures, with efficiency

$$E = \frac{N ( {T}_{e} + {T}_{r} + {T}_{s} )}{M ( {T}_{e}^{≯} + {T}_{r} ) + {T}_{s}} = \frac{N ( {T}_{e} + {T}_{r} + {T}_{s} )}{M ( \frac{N}{M} {T}_{e} + {T}_{r} ) + {T}_{s}} = \frac{N ( {T}_{e} + {T}_{r} + {T}_{s} )}{{NT}_{e} + {MT}_{r} + {T}_{s}}$$

which means E=N if Tₛ is dominant, and

$$E = \frac{N}{M}$$

if Tᵣ is dominant.

When the read noise is dominant, equation 4 gives

$$\frac{MK}{N} {F}_{\overline{c}} \approx \frac{MK}{N} {T}_{e}^{≯} {g}_{\overline{c}} + {\sum }_{\{ i s . t \overline{cε} \text{?} \}} {r}_{t} ( x )$$

$$\text{?} \text{indicates text missing or illegible when filed}$$

The SNR when using multiplexed imaging is then:

$${SNR}^{≯} = \frac{\frac{MK}{N} {T}_{e}^{≯} {g}_{\overline{c}}}{\sqrt{\frac{MK}{N}} {σ}_{r}}$$

Hence, if

$${T}_{e}^{≯} = \frac{{T}_{e}}{\sqrt{\frac{MK}{N}}}$$

condition is chosen, we get

$${SNR}^{≯} = \frac{\frac{MK}{N} {T}_{e}^{≯} {g}_{\overline{c}}}{\sqrt{\frac{MK}{N}} {σ}_{r}} = \frac{{T}_{e} {g}_{\overline{c}}}{{σ}_{r}}$$

which is equal to the original SNR. From this, the efficiency can be obtained:

$$E = \frac{N ( {T}_{e} + {T}_{r} + {T}_{s} )}{M ( {T}_{e}^{≯} + {T}_{r} ) + {T}_{s}} = \frac{{NT}_{e}}{{MT}_{e}^{≯}} = \frac{N \sqrt{\begin{matrix}MK \\ N\end{matrix}} {T}_{e}}{{MT}_{e}} = \sqrt{\frac{NK}{M}}$$

In this case, the efficiency depends on the choice of N, M and therefore there is a difference between the charting mode and the re-observing mode. In re-observing, only extraction of the flux of most sources is needed, neglecting overlapping stars, and therefore typically the condition N=K and M=1 is used, meaning that

$$E - \sqrt{\frac{KK}{1}} - K .$$

When charting, the efficiency depends on the parameters N, M which are somewhat free to the choice of the system designer.

It should be noted that when K<<N, using some reasonable parameters from the simulations, M=2 log₂(N), N=2K, the efficiency

$$E = \frac{K}{\sqrt{i o \text{?} ( N )}}$$

$$\text{?} \text{indicates text missing or illegible when filed}$$

can be obtained which is typical for most applications.

There are many possible applications of the multiplexed imaging technique of the present invention, and the invention can increase the capability of many scientific missions operating in the visible, UV and IR (from space). The technique of the invention (multiplexed imaging) is powerful for sky surveys from space because of the combination of the following factors: Detectors are more expensive to operate in space, and the multiplexed imaging technique may reduce the amount of expensive space-qualified hardware. Further, the background noise is substantially lower from space than from the ground. Also, there are no atmospheric aberrations, meaning that the PSF when imaging from space is substantially smaller, reducing Pd, allowing for higher multiplexing.

The simulations conducted by the inventors show that one can use multiplexing as high as K=175 with charting mode, leading to increased area coverage per unit time by a factor of

$$\sqrt{\frac{350 ≯ 175}{18}} \approx 6 C .$$

Additionally, the invention can be used along with the lucky imaging method, which is a technique of decreasing the effects of atmospheric aberrations using high frequency imaging. When imaging at high frequency, the dominant noise source is the read noise, meaning that high multiplexing is useful. It should be noted that the current charting recovery algorithm is not suitable for this approach, because objects that fall on the same detector area will interfere differently on each sub-observation, as a result of the atmospheric aberrations. Therefore, the logical limit set by the object density is lower than the bound obtained from the object density, to prevent the interference of objects. Since high-speed detectors are small and expensive, using the multiplexed imaging method makes the lucky imaging technique more useful for imaging larger sky areas. This might provide an increase in the range of 100 fold (assuming colliding sources are not allowed) to 1000-fold (assuming they are allowed) in the area observed.

Astronomers use high frequency observations (˜50 Hz) to search for rapid changes in the light flux coming from stars, e.g caused by random occultations by Kuiper belt objects or by intrinsic changes of the stellar flux (e.g, astroseismology, astroseismology). In this scientific use, the dominant source of noise is either the read-noise or the Poisson noise, allowing for using the high multiplexing technique. This might provide an increase of up to 1000 in the amount of stars that will be monitorable.

When searching for transients, one seeks the appearance of new objects in the field of view. This means that in principle astronomers try to image as wide an area as possible, observing the same area of sky over and over again. With the multiplexed imaging of the invention, the re-observing mode can be used for this purpose.

From the ground, when the background noise is dominant, the multiplexing technique facilitates making shallow all-sky surveys 10-fold to 100-fold more effective, increasing the cadence and reducing the efficiency drop due to slew time. When designing new instruments, multiplexed imaging provides for reducing the cost of survey telescopes, allowing for the use of smaller detectors, larger f-numbers and reducing the demands from the physical machinery. From space, the dominant noise source is either read-noise or Poisson noise. The use of the technique of the invention improves this up to a factor of 1000, depending on the density of the area observed.

Another attractive application of the invention is in searching for planets, eclipsing binaries and micro-lensing events. These applications involve monitoring bright stars regularly, to detect flux decrements due to occultation of the star by a planet or an increase of flux due to a lensing event. The flux variability scale can be as small as 0.0001%. At these levels of precision, the dominant noise is the Poisson noise, allowing for high multiplexing to be very effective. It will be especially beneficial when making shallow homogeneous searches for planets. The invention provides for improvement factor of up to 1000 when searching non-dense sky areas, and roughly 10 when monitoring dense regions of the sky.

Thus, the use of the technique of the invention provides a new generation of wide-field surveying space telescopes as well as efficient ground-based instruments for lucky imaging, fast photometry, and transient and variability surveys. It should be noted, although not specifically exemplified, that the technique of the invention may be advantageously used for many applications, other than astronomical, for example in medical application, material science, etc.

1. An imaging method comprising:
segmenting an image of a field of regard in an effective object plane, the segmented image being formed by an array of N image parts of the field of regard; and
sequentially projecting a selected number M≧1 of patterns of structured light onto a detection surface, located in a plane conjugate to the effective object plane;
wherein each of the M patterns of structured light being formed by selected Kᵢ components of the N image parts, where i=1 . . . M and 1≦K≦N, and wherein the Kᵢ selected image parts are concurrently projected onto the entire detection surface thus forming a superposition of the Kᵢ image parts;
thereby enabling reconstruction of the image of the field of regard from the selected number M of patterns of the structured light.

2. The imaging method according to claim 1, providing for imaging the relatively wide field of regard on a relatively small detection surface with high spatial resolution, wherein
the segmenting comprises dividing an effective image surface in the effective image plane into an array of N parts, thereby enabling formation of the segmented image of the field of regard in the form of the array of N image parts thereof.

3. The imaging method according to claim 1, comprising: utilizing a-priori data about the field of regard, for processing data indicative of the superposition image, and performing measurements of sources within the image of the field of regard.

4. The imaging method according to claim 1, wherein the predetermined number of patterns is M=1.

5. The imaging method according to claim 1, wherein the Kᵢ image parts are selected such that each of the N image parts is included in at least one of the M patterns.

6. The imaging method according to claim 1, wherein the field of regard is sparse.

7. An imaging system comprising:
an optical assembly, and a light detection unit, wherein:
the optical assembly comprises a segmenting arrangement having an array of N optical elements, arranged in an effective object plane, and configured to form an array of N optical paths;
each of the optical elements comprising collimating optics configured to receive and project a light portion corresponding to a respective one of the N optical paths, thus one of N image parts of a field of regard, the optical assembly therefore configured to divide an image of the field of regard into the N image parts and create a segmented N-part image; and
the light detection unit comprises a detection surface, located in a plane conjugate with the effective object plane, and configured to detect at least one of the N image parts, projected by the optical assembly.

8. The imaging system according to claim 7, wherein the effective object plane is at a predetermined distance with respect to an image plane of a light collecting and focusing optics, such that input light coining from the collecting and focusing optics, and being indicative of an image of the field of regard, exits the optical elements in a form of N collimated light components.

9. The imaging system according to claim 8, wherein the effective object plane is located at one focal distance from the image plane of the collecting and focusing optics.

10. The imaging system according to claim 8, wherein the N optical elements are formed by a pair of co-aligned lens arrays defining N pairs of matching lenses from the two arrays having a focal length f, a size of each of the lens in the array being similar to the size of the detection surface, the effective object plane located at a distance f from the image plane of the collecting and focusing optics.

11. The imaging system according to claim 7, further comprising an image controller configured and operable to operate the segmenting arrangement for sequential projection of M different patterns of structured light onto the detection surface;
wherein each of the M patterns being formed by selected Kᵢ components of the N image parts, where i=1 . . . M and 1≦K≦N, and wherein the Kᵢ selected image parts are concurrently projected onto the entire detection surface to form a superposition of the Kᵢ image parts,
further wherein the Kᵢ image parts are selected such that each of the N image parts is included in at least one of the M patterns, thereby a sequential focusing of each of the M patterns onto the detection surface and enables a reconstruction of the image of the field of regard from the sequentially detected M different patterns of the structured light.

12. The imaging system according to claim 7, wherein the N optical elements are substantially identical.

13. The imaging system according to claim 11, wherein the image controller is configured and operable to activate and deactivate the optical elements to project the M patterns of Kᵢ image parts onto the detection surface.

14. The imaging system according to claim 7,
wherein the system is further configured and operable to communicate data indicative of the sequence of the M patterns to a processor utility for reconstruction of the image of the field of regard.

15. The imaging system according to claim 7, further comprising a processor utility configured to receive and process data indicative of the sequence of the M patterns and to reconstruct the image of the field of regard.

16. The imaging system according to claim 7, further comprising a collecting and focusing optics defining the image plane, and wherein the effective object plane is located at a predetermined distance with respect to the image plane, and wherein the system further comprising a secondary focusing optics configured to focus the collimated beams onto the detection surface.

17. The imaging system according to claim 7, wherein the detection surface is a light sensitive surface of a photodetector unit.

18. The imaging system according to claim 7, wherein the detection surface is an optical window configured to project the focused light onto a light detection plane of an optical measurement unit.

19. The imaging system according to claim 7, wherein the N image parts are of substantially identical geometry and size, and wherein the detection surface has geometry and size substantially of one of the image parts.

20. The imaging method according to claim 1, wherein the N image parts are of substantially identical geometry and size, and wherein the detection surface has geometry and size substantially of one of the image parts.
